(19) United States
(12) Patent Application Publication
(10) Pub. No.: US 2009/0164670 A1
(43) Pub. Date: Jun. 25, 2009

(54) PRINTER AND USB DEVICE RECOGNIZING METHOD

(75) Inventor: Katsumi Nakano, Kitakyushu-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/338,920

(22) Filed: Dec. 18, 2008

(30) Foreign Application Priority Data
Dec. 19, 2007 (JP) 2007-326866

(51) Int. Cl. G06F 3/00

(52) U.S. Cl. 710/18

(57) ABSTRACT

A printer includes a USB host controller and a USB root hub with a plurality of USB ports, in which the USB host controller outputs a bus reset signal to the USB device connected to a specific port when a predetermined standby time passes after a pull-up of a D+/D− signal line of a USB device connected to at least one specific port of the plurality of USB ports is detected.

### CROSS-REFERENCES TO RELATED APPLICATIONS

This application claims priority to Japanese Patent Application No. 2007-326866, filed Dec. 19, 2007, the disclosure of which is incorporated by reference herein.

### BACKGROUND

1. Technical Field

The present invention relates to a technique for connecting an USB device to a printer.

2. Related Art

JP-A-2002-202856 (paragraph 0015, FIG. 2, etc.) discloses an USB interface. The USB interface includes two signal lines D+/D− for performing communication between an USB host and an USB device and a power supply line (VBUS) for enabling power supply to the USB device from the USB host. The USB interface is structured to enable power supply to the USB device, such as a floppy (registered trademark) disk drive (FDD) connected to the USB host such as a personal computer (PC) and a printer. The USB standard specifies that communication speed of the USB device is notified to the USB host in a manner such that when power is supplied to the USB device via a power supply line VBUS or an AC adapter, either the signal line D+ or the signal line D− is pulled up according to communication speed of the USB device. An exemplary method of pulling up the signal line is shown in FIG. 5.

FIG. 5 shows an example of a pulling up method of a signal line. As shown in FIG. 5, a signal line D_{X} (D+/D−) is connected to a pull-down resistor R_{D} so that the signal line D_{X} is pulled down in the state in which the USB device is not connected to the USB host. Either one of two signal lines of the USB device is connected to a power supply line VBUS via a pull-up resistor R_{U} according to communication speed of the USB device and therefore the signal line is pulled up as soon as the USB device is connected to the USB host. The connection of the USB device to USB host is detected by the pulled-up state of the signal line D_{X}. After detecting the USB device, the USB host outputs a bus reset signal to the USB device. When the USB device receives the bus reset signal from the USB host, the USB devices performs initial setting of an USB interface provided therein during a period (at least 10 milliseconds) in which the outputting of the bus reset signals ends. After the outputting of the bus reset signal ends and the initial setting of the USB interface is completed, the USB host performs an address setting of the USB device. That is, enumeration processing is performed.

However, the known USB interface is disadvantageous in that not only the initial setting of the USB interface provided in the USB device is needed to perform normal communication between the USB host and the USB device, but also a CPU, a memory, and etc. provided in the USB device must be completely initialized before the initial setting. However, since it takes a time longer than the period in which the bus reset signal is output to perform the initialization processing, the signal line D_{X} is likely to be pulled up as soon as the USB device is connected to the USB host while the initialization of the USB device is not completed in the above-described structure. If the initialization of the USB device is not completed, the communication between the USB host and the USB device cannot be normally performed after the outputting of the bus reset signal although the USB host outputs the bus reset signal in response to the pulled-up state of the signal line D_{X}.

### SUMMARY

An advantage of some aspects of the invention is that it provides a printer which can be surely connected to a USB device and a method of recognizing a USB device.

According to one aspect of the invention, there is provided a printer including a USB host controller, and a USB root hub with a plurality of USB ports, in which the USB host controller outputs a bus reset signal to the USB device connected to a specific port when a predetermined standby time passes after a pull-up of a D+/D− signal line of a USB device connected to at least one specific port of the plurality of USB ports is detected.

According to another aspect of the invention, there is provided a method of recognizing such a USB device connected to a USB root hub having a plurality of USB ports using a USB host controller, including allowing the USB host controller to output a bus reset signal to the USB device connected to a specific port when a predetermined standby time passes after a pull-up of a D+/D− signal line of the USB device connected to at least one specific port of the plurality of USB ports of the USB root hub is detected.

According to such an aspect, the USB host controller outputs the bus reset signal to the USB device when a predetermined standby time passes after the pull-up of the D+/D− signal line of the USB device connected to at least one specific port of the plurality of USB ports of the USB root hub. Accordingly, the initialization of the USB device is completed during the standby time although the initialization is not completed when the signal line is pulled up. Accordingly, since the USB host controller outputs the bus reset signal to the USB device after the initialization of the USB device connected to the specific port is completed, the USB host controller surely recognizes the USB device after the bus reset signal is output, and surely establishes connection to the USB device. For this instance, it is preferable that times required to initialize various USB devices are obtained beforehand and then the standby time is set on the basis of the obtained value.

It is preferable that the USB host controller may output the bus reset signal again to the USB device after outputting the bus reset signal to the USB device connected to the specific port. With this method, it is possible to surely establish connection to the USB device by outputting the bus reset signal to the USB device again even in the case in which the USB host controller cannot be normally connected to the USB device connected to the specific port although the bus reset signal is output after the standby time passes.

The specific port may be the USB port for enabling connection with an external device. According to this structure, it is possible to surely establish connection to the external device even if the pulled-up signal line D+/D− is connected USB device although the USB device is an unauthentic external device which is not adjusted to be connected to the USB host controller and initialization of the external device is not completed, because the bus reset signal is output after the initialization of the external device is completed in the standby period.

### BRIEF DESCRIPTION OF THE DRAWINGS

The invention will be described with reference to the accompanying drawings, wherein like numbers reference like elements.

FIG. 1 is a perspective view illustrating a photo-printer according to one embodiment of the invention.

FIG. 2 is a schematic view illustrating an inside structure of the photo-printer.

FIG. 3 is a block diagram illustrating main part of a structure of a controller.

FIG. 4 is a view illustrating an example of USB recognition processing.

FIG. 5 is a view illustrating an exemplary method of pulling up a signal line.

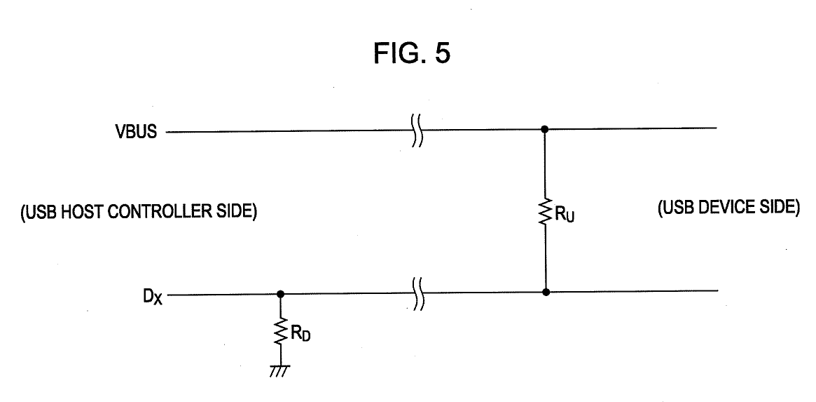

### DESCRIPTION OF EXEMPLARY EMBODIMENTS

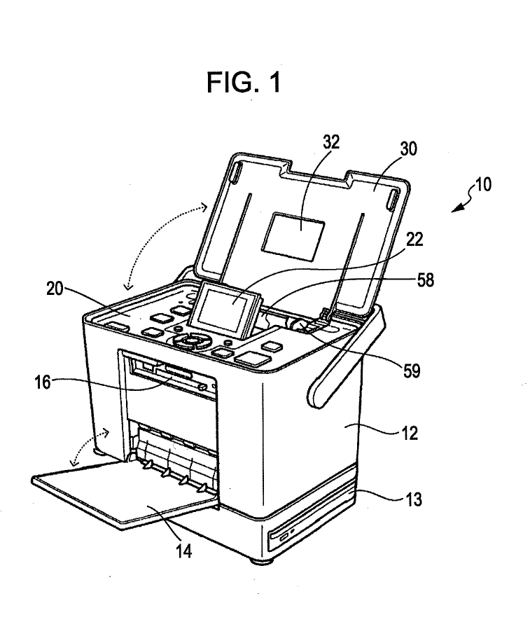

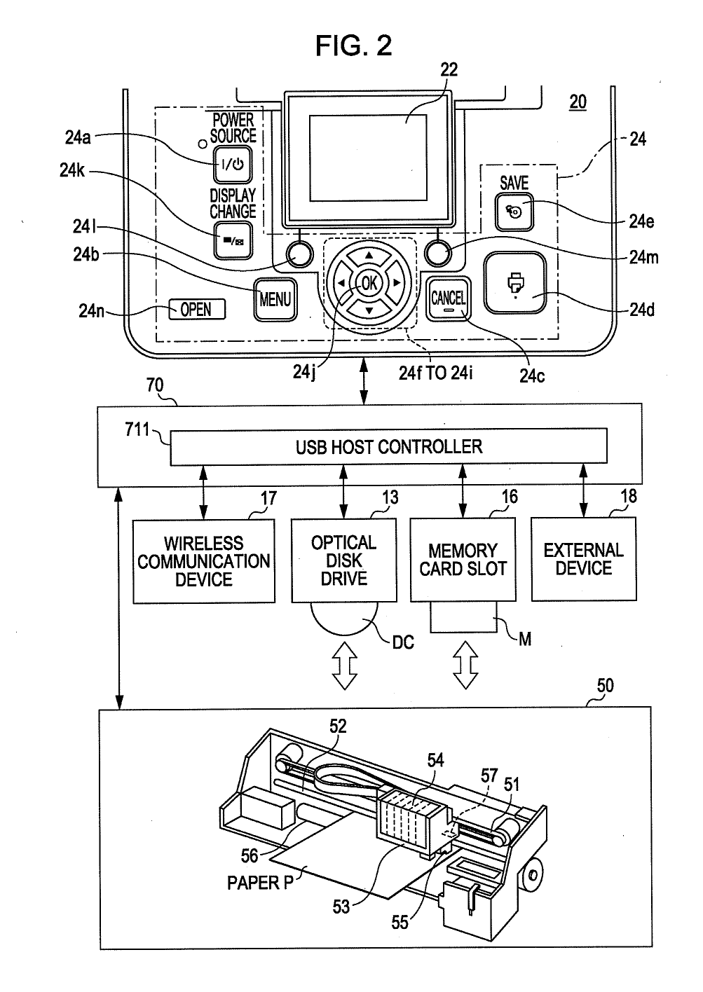

FIG. 1 is a perspective view showing a photo-printer which is a printer according to one embodiment of the invention. FIG. 2 a schematic view illustrating an inside structure of the photo-printer. In the photo-printer 10, a print mechanism 50 (see FIG. 2) is embedded inside a printer body 12 and performs printing to paper P in response to an operation command instruction from a controller 70 (see FIG. 2) which is in charge of control of the entire printer 10. The paper on which the printing is performed is discharged toward a front side of the printer body 12.

On the front face of the printer body 12, as shown in FIG. 1, a front door 14 is disposed in a freely openable manner. The front door 14 is a cover for opening and closing the front face of the printer body 12. When the front door is open, the front door serves as a paper discharge tray for receiving paper P discharged from the print mechanism 50, and a user can use various kinds of memory card slots 16 disposed on the front side of the printer body 12. That is, in the open state of the front door, the user can insert a memory card M storing an image file which is a print object into a memory card slot 16. Furthermore, with this embodiment, in addition to the memory cards, a disk (DC), such as an audio compact disk (CD) and a video digital versatile disk (DVD) can be used as a recording medium. That is, an optical disk drive (ODD) 13 may be disposed in a base portion of the printer body 12.

The upper face of the printer body 12 is provided with an operation panel 20. A cover 30 is attached to an inner edge of the upper face of the printer body 12 in a freely openable manner. The cover 30 is a molded resin plate having a size as large as being capable of covering the upper face of the printer body 12. In the open state, the operation panel 20 is exposed to the outside (see FIG. 1). On the other hand, in the closed state of the cover 30, the entire portion of the operation panel 20 is covered by the cover.

The operation panel 20 is provided with a display portion 22 which displays characters, diagrams, symbols, and etc. and a button group 24 placed around the display portion 22. As shown in FIG. 2, the button group 24 includes a power supply button 24a for switching on and off power, a menu button 24b for calling for a main menu screen, a cancel button 24c for canceling an operation in the middle of the operation or suspending printing to the paper P in the middle of the printing, a print button 24d for instructing the print mechanism to perform printing to the paper P, a save button 24e for saving an edited image to the memory card M inserted in the memory card slot 16, up, down, left, and right arrow buttons 24f, 24g, 24h, and 24i for selecting a desired selection item from a plurality of selection items displayed in the display portion 22 or moving a cursor, an OK button 24j placed in the middle of the arrow buttons 24f, 24g, 24h, and 24i for determining the selection item selected by the arrow buttons 24f, 24g, 24h, and 24i, a display change button 24k for changing a screen display in the display portion 22, a left guide selection button 24l for selecting a left guide displayed in the display portion 22, a right guide selection button 24m for selecting a right guide displayed in the display portion 22, and a paper discharge tray open button 24n for opening the front door 14 functioning as a paper discharge tray.

A window 32 having the same size as the display portion 22 is disposed on the cover 30 to allow the display contents of the display portion 22 to be checked. That is, when the cover 30 is in the open state, the user can check the display contents of the display portion 22 through the window 32. On the other hand, when the cover 30 is in the open state, the display portion 22 can be adjusted at a desirable angle, as shown in FIG. 1.

When the cover 30 is in the open state in this manner, the cover 30 is maintained in an inclined posture in which it inclines with respect to the operation panel 20 toward the rear side, and is used as the tray for supplying the paper P to the print mechanism 50. Inside the operation panel 20, a paper feeding opening 58 of the print mechanism 50 is provided and a pair of paper guides 59 and 59 which are adjusted to slide in the left and right directions so that the width of the guides fit the paper width.

The paper P is sent to the print mechanism 50 via the paper feeding opening 58 and the printing is performed. As shown in FIG. 2, a carriage 53 is driven by a timing belt 51 stretched in a loop form in left and right directions and is reciprocated left and right along the guide 52 in the print mechanism 50. The carriage 53 is provided with a paper end detection sensor 57 and therefore detects left and right ends or front and rear ends of the paper P. That is, the paper detection sensor 57 detects the left and right ends of the paper set in the paper feeding opening 58 when the carriage 53 scans in the left and right directions before the printing so that the paper width can be recognized and detects the rear end of the paper in the middle of the printing so that the paper length can be recognized.

The carriage 53 mounts ink cartridges 54 which separately contain various colors of ink, such as cyan, magenta, yellow, black, and etc. therein. These ink cartridges 54 are connected to print heads 55, respectively. The print heads 55 discharge ink toward the paper P from nozzles (not shown) by applying pressure to ink in the ink cartridges 54. In this embodiment, the print heads adopt a system in which a voltage is applied to piezoelectric elements to deform the piezoelectric elements 55 so that pressure is applied to ink. However, the print heads 55 may adopt a system in which a voltage is applied to an exothermic resistor (for example, heater) to heat the ink to generate bubbles so that pressure is applied to the ink. The paper P on which the printing is performed is sent outside through the front door (paper discharge tray) 14 which is in the open state by a transporting roller 56.

A rear face of the printer body 12 is structured to mount a battery pack thereon so that the printer 10 can operate by batteries without connection with a commercial power supply. The printer 10 is a stand alone printer which can be used without connection with a host computer and the printer 10 can be easily carried and used.

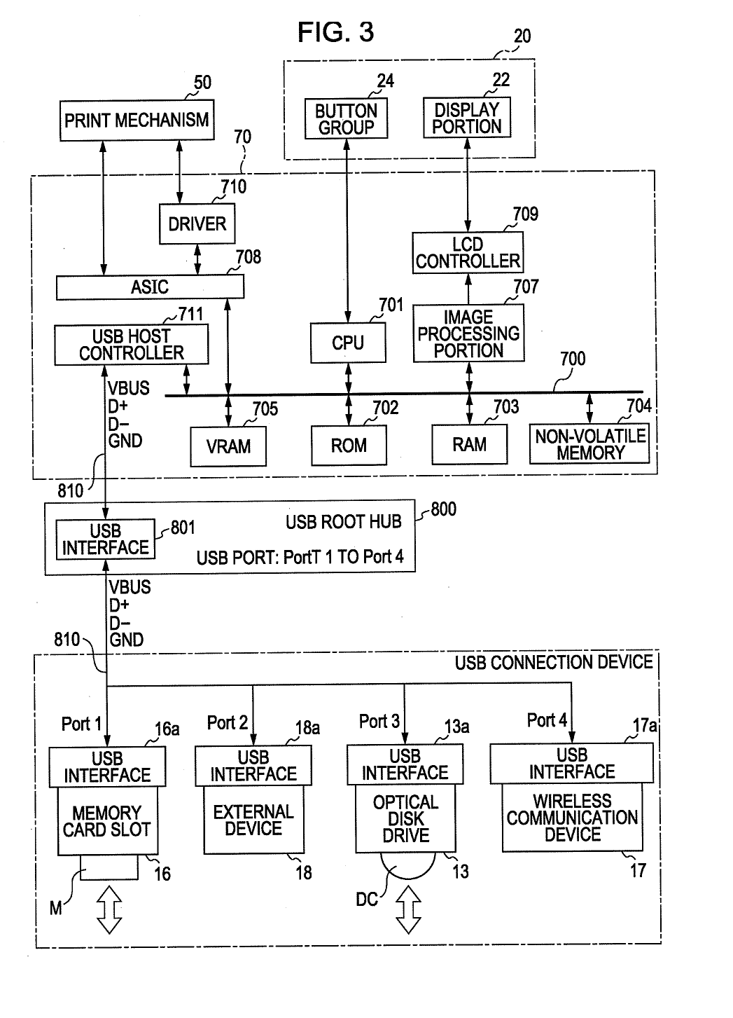

As shown in FIG. 2, the controller 70 is equipped with a universal serial bus (USB) host controller 711 and is connected to a wireless communication device 17, an ODD 13, an external device 18, such as a host computer and a USB memory, and a memory card slot 16 based on the Bluetooth (registered trademark) standard and the IrDA standard according to the USB standard. Data of the image file in the memory card M inserted in the memory card slot 16 as well as a detection signal from a paper end detection sensor 57 of the print mechanism 50 and an instruction signal from the button group 24 of the operation panel 20 and a host computer are input to the controller 70. The controller 70 saves an edited image to the memory card M as well as outputs control signals to the print heads 55 of the print mechanism 50 and the display portion 22 of the operation panel. Further, the controller 70 performs control processing according to manipulation results of the buttons of the button group 24. Next, the controller 70 will be described in detail with reference to FIG. 3.

FIG. 3 shows main part of a structure of the controller 70. As shown in FIG. 3, a system bus 700 of the controller 70 is connected to a CPU 701, a ROM 702, a RAM 703, a non-volatile memory 704, a VRAM 705, an image processing portion 707, an ASIC 708, and a USB host controller 711. The CPU 701 performs computing processing for performing operation processing of the print mechanism 50. The ROM 702 stores a program (firmware) needed to control the CPU 701. The RAM 703 temporarily stores data, the non-volatile memory 704 stores various kinds of data and tables needed to control the CPU 701, and the VRAM 705 stores image data which must be drawn in the display portion 22.

The USB host controller 711 is connected to a USB root hub 800 via a USB cable 810 and the USB root hub 800 is connected to the memory card slot 16 via the USB cable 810. The USB host controller 711 performs communication with the memory card slot 16 (USB interface 16a) via a USB interface 801 of the USB root hub 800 and is structured to be able to read the image data of an external memory medium, such as the memory card M, inserted in the memory card slot 16. The USB host controller 711 sends the image data to the memory card slot 16 by performing communication with the memory card slot 16 (USB interface 16a) for saving the edited image to the memory card M. The USB host controller 711 will be described below in detail.

The image processing portion 707 performs required image processing with respect to the image data which is read from the external memory medium such as the memory card M via the USB host controller 711. The image processing 707 has a function of producing display data which corresponds to a printer specific image such as a menu screen and which is to be displayed in the display portion 22. Data produced by synthesizing the display data and the processed image data is given to the LCD controller 709 from the image processing portion 707, and the display of the display portion 22 is controlled by the LCD controller 709. The ASIC 708 includes a speed control circuit for controlling speeds of a motor (not shown) which transports the paper P provided in the print mechanism 50 and a motor (not shown) which rotates the timing belt 51 and a drive control circuit for controlling a drive of the print heads 55. The ASIC 708 sends the motor control signal and the print head control signal of the print heads 55 which are produced on the basis of the control signals from the CPU 701 to the drive circuit (driver) 710. Detection data of the sensor 57 is input to the CPU 701 via the ASIC 708.

Next, USB connection devices 16, 18, 13, and 17 connected via the USB host controller 711 will be described with reference to FIG. 3. As shown in FIG. 3, the USB host controller 711 is connected to the USB root hub 800 having a plurality of USB ports Port 1, Port 2, Port 3, and Port 4 via the cable 810. The USB is structured in a manner such that physical connection and data communication of the USB is established between the USB host controller 711 and the USB interface 801 of the USB root hub 800. In this embodiment, the USB ports Port 1, Port 3, and Port 4 of the USB root hub 800 are connected to the memory card slot 16, the ODD 13, and the wireless communication device 17 are connected via the USB cable 810. The memory card slot 16, the ODD 13, and the wireless communication device 17 are embedded in the printer body 12 and are disposed in a manner such that the USB connector (not shown) connected to the USB port Port 2 is exposed to the outside of the printer body 12 so that the external device 18 can be connected to the USB port Port 2.

The USB host controller 711 and the USB interfaces 16a, 13a, and 17a provided in the memory card slot 16, the ODD 13, and the wireless communication device 17, respectively are structured so as to establish the physical connection and data communication of the USB via the USB interface 801 of the USB root hub 800. In the case in which the external device 18 is connected to the USB port Port 2, the physical connection of USB and the data communication between the USB host controller 711 and the USB interface 18a of the external device 18 are established via the USB interface 801 of the USB root hub 800 like other USB connection devices. As described above, the memory card slot 16, the external device 18, the ODD 13, and the wireless communication device 17 correspond to “USB devices” of the invention.

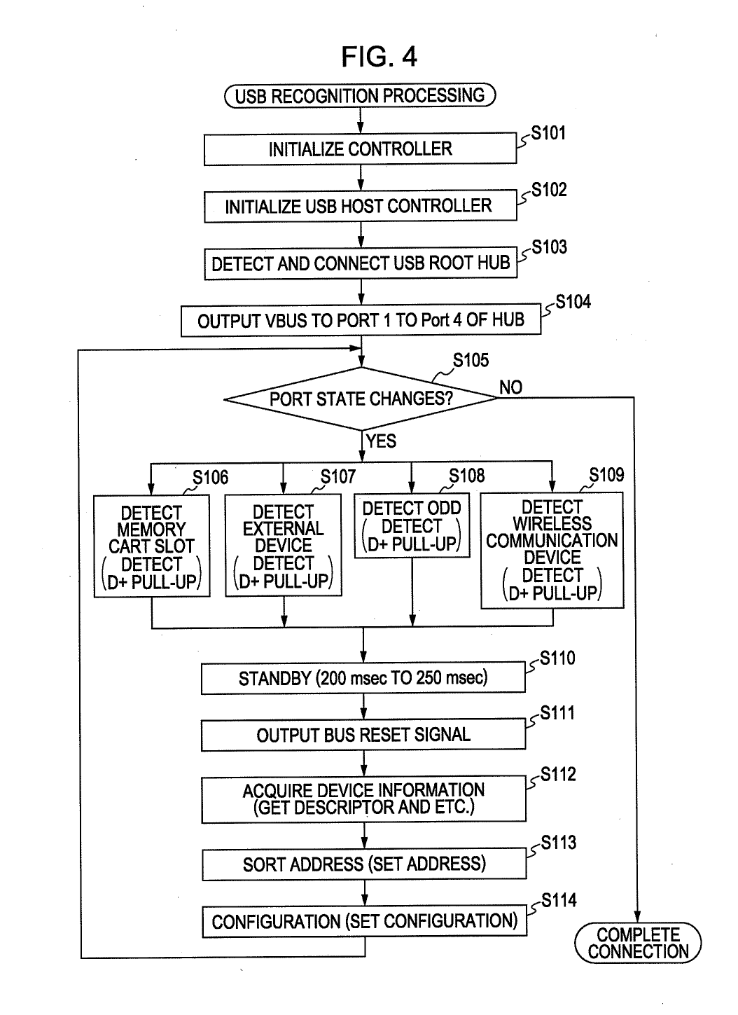

In this embodiment, when power is supplied to the photo-printer 10, initialization of the CPU 701, the memories 702, 703, 704, and 705, the ASIC 708, and the USB host controller 711 provided in the controller 70 is performed. When the initialization of the USB host controller 711 is completed, power supply to the USB root hub 800, the memory card slot 16, the external device 18, the ODD 13, and the wireless communication device 17 via the power supply line VBUS starts. The memory card slot 16, the external device 18, the ODD 13, and the wireless communication device 17 notifies communication speeds thereof to the USB host controller 711 by pulling up signal lines D+ and D− according to communication speeds (full speed, low speed, and high speed) of these devices when the power supply (VBUS output) to these devices via the power supply line VBUS is performed. The USB host controller 711 outputs a bus reset signal to the USB devices 16, 18, 13, and 17 according to the pull-up of the signal lines D+ and D−, recognizes the USB devices 16, 18, 13, and 17 by executing enumeration processing in which an address setting of each of the USB devices 16, 18, 13, and 17 is performed, and performs connection processing with the USB devices 16, 18, 13, and 17. Next, an example of USB recognition processing in which the USB host controller 711 recognizes USB connection devices when power is supplied to the photo-printer 10 will be described with reference to FIG. 4.

FIG. 4 shows an example of the USB recognition processing. In this embodiment, to simplify explanation, each of the memory card slot 16, the external device 18, the ODD 13, and the wireless communication device 17 is a USB device having full speed communication capability. According to the explanation, if power supply (VBUS output) from the USB host controller 711 via the power supply line VBUS is enabled, the signal line D+ is pulled up. As for communication speed of each of the USB devices 16, 18, 13, and 17, the signal line D− may be pulled up at low speed. The USB devices 16, 18, 13, and 17 may have high speed communication capability. First of all, when the power is supplied to the photo-printer 10, initialization of the controller 70 is started (step S101). When the initialization of the USB host controller 711 is completed (step S102), detection and connection of the USB root hub 800 are performed (step S103).

Next, power is supplied to the USB devices 16, 18, 13, and 17 via the power supply line VBUS connected to the USB ports Port 1, Port 2, Port 3, and Port 4 of the USB root hub 800 (VBUS output, step S104), and then it is detected whether the state of each of the USB ports Port 1, Port 2, Port 3, and Port 4 changes, i.e. whether the signal line D+is pulled up (Step S105). If one USB port of the USB ports Port 1, Port 2, Port 3, and Port 4 is detected by the USB host controller 711 (that is, it is detected that the signal line D+ of either one of the memory card slot 16, the external device 18, the ODD 13, and the wireless communication device 17 is pulled up) (steps S106, S107, S108, and S109), the USB host controller 711 waits until a predetermined standby time (200 to 250 milliseconds) passes (Step S110)

The USB host controller 711 outputs a bus reset signal to the detected USB device of which the signal line D+ is pulled up (step S111). In greater detail, the bus reset signal is output by maintaining a voltage of the signal line D+ or D− at a low level for at least 10 milliseconds. The USB host controller 711 acquires USB device information by acquiring a descriptor after outputting the bus reset signal (step S112), set an address of the USB device (step S113), and finally configures the USB device (step S114). After that, the processing progresses to step S105.

In Step S105, if there is another USB device of which the signal line D+ is pulled up, processing of steps S110, S111, S112, S113, and S114 is performed again with respect to the USB device. If the answer is NO in step S105, that is, when recognition processing with respect to all of the connected USB devices 16, 18, 13, and 17 is completed, the USB recognition processing ends. In this embodiment, all of the USB ports Port 1, Port 2, Port 3, and Port 4 function as “specific ports” in the invention.

As described above, in this embodiment, the USB host controller 711 outputs bus reset signals to the USB devices 16, 18, 13, and 17 when a predetermined standby time (200 to 250 milliseconds) passes after the pull-up of the signal line D+ or D− of each of the USB devices 16, 18, 13, and 17 connected to a plurality of USB ports Port 1, Port 2, Port 3, and Port 4 provided in the USB root hub 800 is detected. Accordingly, even if initialization of the USB devices 16, 18, 13, and 17 is not finished when the signal lines are pulled up, the initialization is completed during the standby time. Since the USB host controller 711 comes to output the bus reset signals to the USB devices 16, 18, 13, and 17 after initialization of the USB devices 16, 18, 13, and 17 connected to the USB ports Port 1, Port 2, Port 3, and Port 4 is completed, the USB host controller 711 can surely recognize the USB devices 16, 18, 13, and 17 after outputting the bus reset signals and surely establish connection to the USB devices 16, 18, 13, and 17. For this instance, it is preferable that a time needed to initialize various kinds of USB devices 16, 18, 13, and 17 is obtained beforehand, and a standby time is set on the basis of the obtained value.

The invention is not limited to the above-mentioned embodiment but various changes may be made as long as the changes are not departed from the spirit of the invention. For example, if the USB host controller 711 fails in the enumeration processing after outputting the bus reset signals to the USB devices 16, 18, 13, and 17, the bus set signals may be output to the USB devices 16, 18, 13, and 17 again. According to this method, in the case in which the USB host controller cannot be normally connected to the USB devices 16, 18, 13, and 17 which are connected to the USB ports Port 1, Port 2, Port 3, and Port 4, respectively, although the USB host controller 711 output the bus reset signals when the standby time passes, since the bus reset signals are output to the USB devices 16, 18, 13, and 17 again, connection of the USB devices 16, 18, 13, and 17 is surely accomplished.

In the above-mentioned embodiment, all of the USB ports Port 1, Port 2, Port 3, and Port 4 function as specific ports of the invention. However, some of the USB ports Port 1, Port 2, Port 3, and Port 4 may function as the specific ports of the invention. For this instance, the following advantage can be obtained by using the USB port Port 2 for connection to the external device 18 as the specific port. That is, the memory card slot 16, the ODD 13, and the wireless communication device 17 embedded in the printer 12 are authentic products and constitute the photo-printer 10. Accordingly, if each of the USB devices 16, 13, and 17 is structured in a manner such that the signal line D+ is pulled up according to the VBUS output of the USB host controller 711 after the initialization of the CPU and the memory is completed in the product design step, the USB host controller 711 can normally perform the recognition processing (enumeration processing) of the USB device after detection of the pull-up of the signal line D+ although the bus reset signals are output before the standby time passes.

On the other hand, since timing at which the USB device serving as the external device 18 and connected to the USB port Port 2 pulls up the signal line D+ or D− depends on the design of the external device 18, although the signal line D+ or D− is pulled up, there is the chance that the initialization of the CPU and the memory constituting the external device 18 is not completed. In particular, if signal processing speed of the IC chip constituting the external device 18 is lowered and a time for initializing the IC chip is needed after the power is supplied, there is strong chance that the initialization of the external device 18 is not likely to be completed when the USB host controller 711 outputs the bus reset signal. However, since the USB port Port 2 functions as the specific port of the invention, the USB host controller 711 surely establishes connection to the external device 18 by outputting the bus reset signal after the standby time passes and the initialization of the external device 18 is completed. Accordingly, in addition to the above-described structure, even if any external device 18, such as the external device 18 which requires a time to complete initialization of the device, is connected, it is possible to surely establish the connection to the external device 18.

In the above-mentioned embodiment, the USB root hub 800 has a structure having four USB ports. However, the number of the USB ports is not limited to four. That is, it is possible to increase the number of USB ports by connecting another USB hub to the USB root hub 800. In the above-mentioned embodiment, the ink cartridge system photo-printer 10 is exemplified as the printer but the invention may be applied to an ink-jet type printer. Further, the invention can be applied to connection of the USB device.

What is claimed is:

1. A printer comprising:
a USB host controller; and
a USB root hub with a plurality of USB ports,
wherein the USB host controller outputs a bus reset signal to the USB device connected to a specific port when a predetermined standby time passes after a pull-up of a D+/D− signal line of a USB device connected to at least one specific port of the plurality of USB ports is detected.

2. The printer according to claim 1, wherein the USB host controller outputs the bus reset signal to the USB device again after outputting the bus reset signal to the USB device connected to the specific port.

3. The printer according to claim 1, wherein the specific port is the USB port for allowing connection with an external device.

4. A USB device recognizing method of recognizing a USB device connected to a USB root hub having a plurality of USB ports by using a USB host controller, comprising:
allowing the USB host controller to output a bus reset signal to the USB device connected to a specific port when a predetermined standby time passes after a pull-up of a D+/D− signal line of the USB device connected to at least one specific port of the plurality of USB ports of the USB root hub is detected.
